(19) United States
(12) Patent Application Publication
(10) Pub. No.: US 2005/0140506 A1
(43) Pub. Date: Jun. 30, 2005

(54) Monitoring system and method for home appliance placed within certain distance

(76) Inventors: Min Jin Oh, Changwon-si (KR); Gyoo Cheol Choi, Changwon-si (KR); Yong Hoan Kwon, Busan-si (KR); Kweon Son, Changwon-si (KR); Yong Tae Kim, Kimhae-si (KR); Hoon Bong Lee, Changwon-si (KR)

Correspondence Address: BIRCH STEWART KOLASCH & BIRCH, PO BOX 747, FALLS CHURCH, VA, 22040-0747, US

(21) Appl. No.: 10/928,089

(22) Filed: Aug. 30, 2004

(30) Foreign Application Priority Data
Dec. 26, 2003 (KR) 10-2003-0097743
Dec. 26, 2003 (KR) 10-2003-0097744
Dec. 26, 2003 (KR) 10-2003-0097749
Dec. 26, 2003 (KR) 10-2003-0097750

(51) Int. Cl. G08B 1/08

(52) U.S. Cl. 340/538; 340/679; 340/310.01; 340/3.1

(57) ABSTRACT

The present invention relates to a monitoring system and method for a home appliance placed within certain distance. The monitoring system includes: an indoor space in which a user lives; a housing space being at a distance from the indoor space; a home appliance being placed in the housing space and having a communication module for communicating with the external of the housing space; and a remote controller placed in the indoor space, for communicating with the communication module to receive monitoring information of the home appliance, thereby monitoring an operation state of the home appliance.

### BACKGROUND OF THE INVENTION

1. Field of the Invention

The present invention relates to a monitoring system and method for a home appliance placed within certain distance. More particularly, the present invention relates to a monitoring system and method for a home appliance placed within certain distance, in which in a case where a user is distant away from the home appliance such as a washing machine and a dryer placed within the certain distance, he/she can conveniently monitor the home appliance. Much more particularly, the present invention relates to a monitoring system and method for a home appliance placed within certain distance, in which in a case where a user is distant away from a place where the home appliance such as a washing machine and a dryer is installed, he/she can more conveniently monitor and control the home appliance.

2. Description of the Related Art

Generally, if a user puts a contaminated laundry in a laundry bath of a washing machine, the washing machine performs a washing stroke using an appropriate mixture of a detergent and washing water, and completes a laundry work through rinsing and drying strokes. Additionally, a dryer sends air to a drying target such as clothes including moisture to remove the moisture from the drying target, thereby drying the drying target.

Further, for an appropriate and beautiful arrangement of an indoor space, the washing machine and the dryer are mostly installed, separately from the indoor space, at a place such as an outdoor warehouse and an underground laundry room separated from a main living space. Therefore, the user goes to a laundry room placed within the certain distance to perform a series of laundry works, thereby causing the user to be inconvenienced. Particularly, in a case where the user directly goes to the laundry room, adaptively to a progress state of the laundry work whenever the washing machine and the dryer performs each of operations such as addition of a fiber-softener, the user should necessarily acknowledge the progress states of the washing machine and the dryer when using the washing machine and the dryer. Further, the user is much inconvenienced in a case where he/she goes to the laundry room at a predetermined time without an acknowledgement of the progress state of the laundry work.

Recently, the washing machine provides the user with more convenience, due to serial automization of an entire process of the laundry work after the laundry is put in the washing machine. However, the above-described full automatic washing machine can stop due to erroneous operation in the course of laundry. Even at this time, there is a drawback in that the user cannot acknowledge the erroneous operation if not going to the laundry room.

Recently, an attempt is being made such that the home appliance is connected to Internet environment to be controlled at a place being within certain distance when the home appliance is needed to operate, thereby easily performing various houseworks without limitation of space and time. As a representative example, a remotely controlling and monitoring method using Internet is provided. However, the above method has a drawback in that a manufacture cost is increased due to a continuous power-on state of a Personal Computer (PC) and home networking. Additionally, the method is not so widely used due to a separate connection unit and a complicated construction for Internet connection.

Accordingly, a device for conveniently monitoring and controlling the home appliance placed within the certain distance is much required. Specifically, in a case where the washing machine and the dryer are used as different units, it is necessarily required to transfer a laundry to the dryer after entire strokes of the washing machine. Therefore, the device will be much more required, in particular.

### SUMMARY OF THE INVENTION

Accordingly, the present invention is directed to a monitoring system and method for a home appliance placed within certain distance, that substantially obviates one or more problems due to limitations and disadvantages of the related art.

An object of the present invention is to provide a monitoring system and method for a home appliance placed within certain distance, in which a user can more conveniently monitor an operation state and an operation progress of the home appliance placed within the certain distance.

Another object of the present invention is to provide a monitoring system and method for a home appliance placed within certain distance, in which a user can conveniently control the home appliance placed within the certain distance when he/she wants to do.

Specifically, a further another object of the present invention is to provide a monitoring system and method for a home appliance placed within certain distance, in which a user can conveniently monitor and control operations of a washing machine and a dryer even without an expensive equipment such as Internet monitoring unit.

A still another object of the present invention is to provide a monitoring system and method for a home appliance placed within certain distance, in which a user can conveniently monitor and control the home appliance such as a washing machine and a dryer wherever the home appliance is installed indoor or outdoor.

A still another object of the present invention is to provide a monitoring system and method for a home appliance placed within certain distance, in which a user can conveniently acknowledge an operation state and a control state of the home appliance placed within the certain distance, thereby providing the user with more convenience.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a monitoring system for a home appliance placed within certain distance, the monitoring system including: an indoor space in which a user lives; a housing space being at a distance from the indoor space; a home appliance being placed in the housing space and having a communication module for communicating with the external of the housing space; and a remote controller placed in the indoor space, for communicating with the communication module to receive monitoring information of the home appliance, thereby monitoring an operation state of the home appliance.

The housing space is an underground room or a warehouse.

The communication module is free to detach from the home appliance.

The communication module and the home appliance are communicated with each other by using one or two of a power line communication, a wireless communication and a wire communication.

The remote controller is fixed to a wall of the indoor space.

The remote controller is portable.

The home appliance is a washing machine and/or a dryer.

The home appliance is provided in plural.

The remote controller has an alarm generating unit for alarming that the home appliance is in abnormal operation.

The remote controller has a displaying unit for displaying monitoring information.

The monitoring system further includes a power unit integrated with the remote controller.

The remote controller has a communicating unit for communicating with the communication module.

The monitoring system communicates with the communication module and is provided separately from the remote controller as a separate unit.

The home appliance and/or the remote controller have/has a key inputting unit for user manipulation.

The home appliance has displaying units for displaying operation states of the home appliance for themselves.

The monitoring information has error information of the home appliance.

Each of the home appliances has a micro processor for controlling an operation of the remote controller and/or the home appliance.

In another aspect of the present invention, there is provided a monitoring method for a home appliance placed within certain distance, the monitoring method including the steps of: analyzing monitoring information of the home appliance from the home appliance placed within the certain distance; transmitting the monitoring information to a remote controller; and displaying the monitoring information on the remote controller.

In a further another aspect of the present invention, there is provided a monitoring method for a home appliance placed within certain distance, the monitoring method including the steps of: transmitting monitoring information of the home appliance from the home appliance to a remote controller; and displaying the monitoring information at a remote controller.

The monitoring method further includes the step of: transmitting a control command for controlling an operation of the home appliance from the remote controller to the home appliance.

The transmitting of the monitoring information is performed when there is a request from the remote controller.

In a still another aspect of the present invention, there is provide a monitoring system for a home appliance placed within certain distance, the monitoring system including: a washing machine and/or a dryer having a communication module to communicate with the external; and a remote controller placed within the certain distance from the washing machine and/or the dryer, for receiving and displaying monitoring information of the washing machine and/or the dryer by communicating with the communication module.

The inventive monitoring system and method has an advantage in that user convenience is more increased, and the home appliance can have much safety by promptly and conveniently correcting a malfunction of the home appliance to again control the home appliance.

Further, the present invention has an advantage in that the user can more comfortably use the home appliance placed within the certain distance. In particular, the present invention can be more conveniently applied to the home appliance that is continuously operates for a long time such as the washing machine and the dryer.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating an applied state of a monitoring system according to an embodiment of the present invention;

FIG. 2 is a view illustrating a construction of a monitoring system according to an embodiment of the present invention;

FIG. 3 is a view illustrating a construction of a monitoring system for a home appliance placed within certain distance according to an embodiment of the present invention;

FIG. 4 is a view illustrating a construction of a monitoring system for a home appliance placed within certain distance according to another embodiment of the present invention;

FIG. 5 is a flowchart illustrating a monitoring method for a home appliance placed within certain distance according to an embodiment of the present invention; and

FIG. 6 is a flowchart illustrating a monitoring method for a home appliance placed within certain distance according to another embodiment of the present invention.

### DETAILED DESCRIPTION OF THE INVENTION

Reference will now be made in detail to the preferred embodiments of the present invention,. examples of which are illustrated in the accompanying drawings.

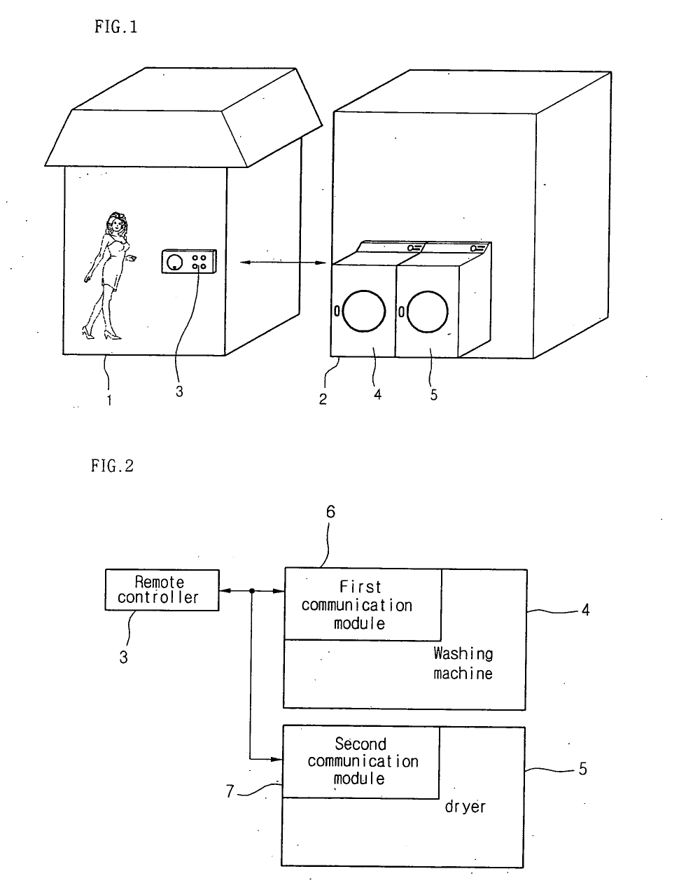

FIG. 1 is a view illustrating an applied state of a monitoring system according to an embodiment of the present invention.

Referring to FIG. 1, a house includes an indoor space 1 where a user lives, and a housing space 2. The housing space 2 is separated from the indoor space 1 to house a home appliance placed within certain distance such as a washing machine 4 and/or a dryer 5. The housing space 2 can be separately provided such as a laundry room and an underground room. Further, a remote controller 3 can be placed within the indoor space 1 where the user lives.

In the case of the indoor space 1 and the housing space 2 being divided, the user carries a laundry to a laundry room and puts it in a washing machine 4, and then, he/she returns to the indoor space 1 and automatically operates the washing machine 4 and the dryer 5 according to a series of processes by a predetermined control command. Additionally, according to a user's desire, the progress states of the washing machine 4 and the dryer 5 can be transmitted to the remote controller 3. The user can see the progress states of the washing machine 4 and the dryer 5 transmitted to the remote controller 3 to acknowledge the time when he/she should go to the washing machine 4 and the dryer 5 or that he/she should perform an additional work.

The remote controller 3 can be also a fixing equipment fixed to an indoor fixing position such as a wall, and can be a mobile equipment suitable to a user's portability. However, the fixing equipment can be conveniently connected with the housing space 2 through a power line communication or a wire communication. The mobile equipment can be associated with the housing space 2 through a wireless communication. However, a displaying unit can be preferably provided at a predetermined position of the remote controller 3 to display an operation state of the washing machine 4 and the dryer 5 by a predetermined signal transmitted from the washing machine 4 and the dryer 5.

FIG. 2 is a view illustrating a construction of a monitoring system according to an embodiment of the present invention.

Referring to FIG. 2, the monitoring system includes the washing machine 4; the dryer 5; the remote controller 3 for monitoring and/or controlling the washing machine 4 and/or the dryer 5; and a first communication module 6 and second communication module 7 mountably provided at the washing machine 4 and the dryer 5.

The washing machine 4 and the dryer 5 can be previously constructed to install the communication modules 6 and 7 for communicating with the external. The communication modules 6 and 7 can be sold as separate units. Additionally, the remote controller 3 can be optionally provided as a separate unit at the time of purchasing. Therefore, in a case where the user wants a remote control according to a fondness and a living environment, he/she can purchase the communication modules 6 and 7 and the remote controller 3 together with the washing machine 4 and the dryer 5, or not purchase. Additionally, in a case where the user does not purchase the communication modules 6 and 7 and the remote controller 3 together when the washing machine 4 and the dryer 5 are purchased, the communication modules 6 and 7 and the remote controller 3 can be also additionally purchased and installed when the home appliance placed within certain distance needs to be controlled.

At this time, the communication modules 6 and 7 should be able to be installed at an appropriate position with reference to a vibration characteristic, a heat characteristic, humidity and the like of the washing machine 4 and the dryer. 5. A data communication between the remote controller 3 and the communication modules 6 and 7 can be performed by using a single one or a combined one of the power line communication, the wire communication and the wireless communication. However, an appropriate communication method can be selected depending on a method of using the remote controller or a house structure.

In more detail, the communication method between the remote controller 3 and the washing machine 4 and the dryer 5 is described. The power line communication can be appropriate depending on the user's living environment. In this case, the wire/wireless communication cannot be performed or there are many obstacles. The communication method can be selected using any appropriate method. At this time, in a case where the power line communication or the wire communication is used, the remote controller 3 can be attached to the indoor space such as a wall surface. In a case where the wireless communication is used, it is desirable that the remote controller 3 can be preferably provided suitably to user's portability.

By this construction, the present invention can perform a direct communication between the remote controller 3 and the communication modules 6 and 7 without using a network such as a gate way and a separate communication network such as Internet.

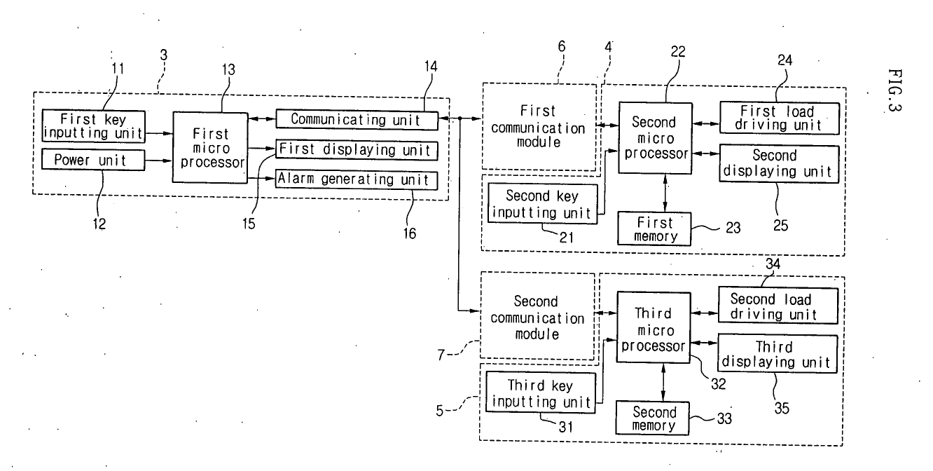

A construction of the inventive monitoring system is in detail described with reference to a construction of the monitoring system for the home appliance placed within the certain distance shown in FIG. 3.

FIG. 3 in detail illustrates constructions of the remote controller 3, the washing machine 4 and the dryer 5.

Firstly, the remote controller 3 includes a first key inputting unit 11 for inputting a user's request command; a power unit 12 for supplying power to the remote controller 3; a communicating unit 14 for communicating with the communication modules 6 and 7 attached to the washing machine 4 and the dryer 5; a first micro processor 13 for monitoring/controlling operation states of the washing machine 4 and the dryer 5 through the communicating unit 14 by the request command inputted through the first key inputting unit 11; a first displaying unit 15 for displaying the operation states of the washing machine 4 and the dryer 5 depending on the control signal of the first micro computer 13; and an alarm-sound generating unit 16 for informing that the washing machine 4 and the dryer 5 are erroneously operated depending on a control signal of the first micro processor 13.

Further, there are provided at a side of the washing machine 4 the first communication module 6 for communicating with the communicating unit 14 of the remote controller 3 and/or with the second communication module 7 provided at the side of the dryer 5; a second key inputting unit 21 for inputting the user's request command; a second micro processor 22 for outputting a control signal to perform a control operation according to the user's request command inputted through the second key inputting unit 21, and communicating for controlling/monitoring through the first communication module 6; a first load driving unit 24 for driving a load according to the control signal of the second micro processor 22; a second displaying unit 25 for displaying the operation state according to the control signal of the second micro computer 22; and a first memory 23 for storing various menus related with the operation of the washing machine.

It is desirable that the first communication module 6 can be selected and connected with a body of the washing machine 4 according to a user's need to be detached from the body. The first load driving unit 24 can include a motor for rotating a drum, and a heater.

Furthermore, there are provided at the side of the dryer 5 the second communication module 7 for communicating with the communicating unit 14 and/or the first communication module 6; a third key inputting unit 31 for inputting the user's request command; a third micro processor 32 for outputting the control signal to perform the control operation according to the user's request command inputted through the third key inputting unit 31, and allowing the monitoring/controlling through the second communication module 7; a second load driving unit 34 for driving the load according to the control signal of the third micro processor 32; a third displaying unit 35 for displaying the operation state according to the control signal of the third micro processor 32; and a second memory 33 for storing various menus related with the operation.

It is desirable that the second communication module 7 can be selected and connected with a body of the dryer 5 according to the user's need to be detached from the body of the dryer 5. The first load driving unit 34 can include a motor for rotating a drum, and a heater.

Referring to FIG. 3, the monitoring method for the home appliance placed within the certain distance is briefly described according to the present invention.

First, after the user puts the laundry in the washing machine 4 or the dryer 5 installed at the housing space 2, he/she inputs an operation command through the key inputting units 21 and 31 to drive the washing machine 4 and/or the dryer 5. After that, the micro processors 22 and 32 output the control signal to the load driving units 24 and 34 such that a corresponding stroke can be performed by the user's command. By doing so, the washing machine 4 performs the corresponding operation, and displays the operation progress state on the displaying units 25 and 35. The laundry putting-in, the key inputting, the operation of the load driving unit using the control signal, and the displaying of the displaying unit can be respectively performed in the same process of the washing machine and/or the dryer.

The operation processes of the washing machine 4 and the dryer 5 can be performed while the user directly sees the displaying units 25 and 35 in the housing space 2.

In most cases, the washing machine 4 performs the washing stroke, and then the dryer 5 performs a drying process after the laundry is transferred to the dryer 5. If the washing machine 4 and the dryer 5 are of an integral type, a separate laundry transferring process can be also unnecessary. At this time, a communication module at which the communicating unit 14 is connected by wire/wireless will be a single point.

According to one feature of the present invention, in a case where the user intends to monitor the operation states of the washing machine 4 and the dryer 5 in the house, the user selects a wanting product among the washing machine 4 and the dryer 5 through the first key inputting unit 11 of the remote controller 3, and inputs a monitoring command. By doing so, the first micro processor 13 recognizes the monitoring command to allow the communication between the communicating unit 14 and the communication module of the user's selecting home appliance among the first and second communication modules 6 and 7 of the washing machine 4 and the dryer 5.

In other words, in a case where the user intends to monitor the operation states of the washing machine 4 and the dryer 5, the communicating unit 14 transmits the monitoring command to the first communication module 6 and/or the second communication module 7. The communication modules 6 and 7 transmit the monitoring command to the micro processors 22 and 32 such that the micro processors 22 and 32 acknowledge each of the corresponding operation states of the home appliances 4 and 5.

The micro processors 22 and 32 can determine a current operation state of the home appliance through the operation states of the load driving units 24 and 34. Additionally, the micro processor 22 and 32 control to transmit the operation states of the washing machine 4 or the dryer 5 to the communicating unit 14 of the remote controller 3 through the communication modules 6 and 7. Additionally, the remote controller 3 inputs monitoring information to the first micro processor 13 through the communicating unit 14. The first micro processor 13 analyzes the received monitoring information to display the operation state on the first displaying unit 15.

Further, if the received monitoring information has error information, the first displaying unit 15 displays an error state and at the same time, informs the user of error generation by using the alarm-sound generating unit 16. In detail, in a case where the washing machine 4 and the dryer 5 are in normal operation, the first displaying unit 15 displays a current operation state of the home appliance 14 and 15. However, in a case where the washing machine 4 and/or the dryer 5 are/is in abnormal operation, an alarm sound and an error message are generated from the alarm-sound generating unit 16 and/or the first displaying unit 15 of the remote controller 3.

Accordingly, since the user can monitor the operation states of the washing machine 4 and the dryer 5 at any time by using the remote controller 3 having easy portability, he/she can confirm completion states of washing and drying, without directly going and seeing and can always confirm whether or not an erroneous operation is generated. Specifically, when the home appliance is in the abnormal operation, the user can promptly detect the abnormal operation to check the operation states of the home appliance, thereby preventing a large mistake.

As described above, the inventive monitoring system and method for the home appliance placed within the certain distance can provide the user with more convenience.

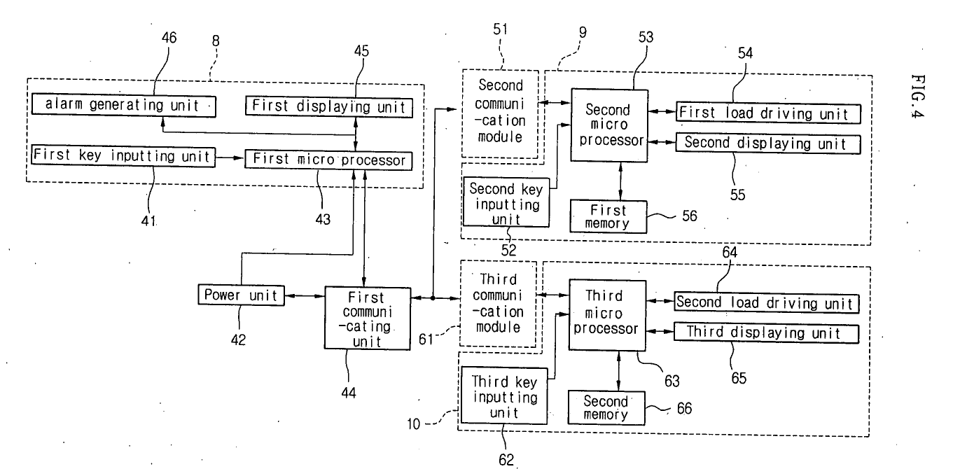

FIG. 4 is a view illustrating a construction of the monitoring system according to another embodiment of the present invention.

Most of parts of this embodiment have the same constructions as those of the above-described embodiment of the present invention. However, this embodiment is different from the above-described embodiment only regarding a part at which the remote controller is placed in an accessible indoor space, and a construction relating to it. In other words, this embodiment provides a power unit 42 and a first communicating unit 44, each being placed at a different position from the remote controller 8 as a separate unit, to make the power line communication or the wire communication suitable to an indoor environment. In particular, the power unit 42 and the first communicating unit 44 are located adjacently to the power line and the wire communication line that are provided indoor in plural. The remote controller 8 can be fixed to the indoor wall at a height of user's eyes such that the user can easily use the remote controller 8. However, it is not excluded that the remote controller 8 is portable by the user as the separate unit. There is a difference in that the power unit is provided adjacently to the power line. Besides, other units housed within the washing machine 9, the dryer 10 and the remote controller 8 have the same constructions and operations as in the above-described embodiment. Therefore, descriptions thereof are omitted.

In detail, the remote controller 8 is attached to the indoor wall surface, and the power unit 42 and the first communicating unit 44 are separated from the remote controller 8 to be disposed adjacently to the indoor power line to which power is supplied. By the above-construction, the power unit 42 and the first communicating unit 44 are distant away from the remote controller 8.

Convenient and economical use is the reason why the remote controller 8 is located adjacently to the power line, and the power unit 42 and the first communicating unit 44 are located at a position to which the user can conveniently access. Further, since the remote controller 3 for controlling various home appliances is increased in number and is lost, thereby making it impossible to perform the remote control, the remote controller 3 is attached to the wall surface to reduce a loss danger. Much convenience is provided when the remote controller 3 is installed at a position suitable to the height of the user's eyes.

In the embodiment of FIG. 3, communication is performed using a wireless communication method to allow the user's convenient portability. In another embodiment of FIG. 4, the communication is performed using a wireless or power line communication method to be applied to a method in which the remote controller is fixed to the wall surface. Even any one of the methods can be mutually changed according to a house structure, a communication environment of the house, a user preference and the like.

In the meantime, the above embodiments provide the same monitoring function of allowing the user to monitor the operation states of the washing machine 4 and the dryer 5 through the remote controllers 3 and 8 at any time. Additionally, the user uses the monitoring function to confirm the washing and drying states, without user's going to the washing machine or the dryer, and also to always confirm whether or not the washing machine or the dryer is erroneously operated. This convenience will be more conspicuous as the indoor space 1 is more distant away from the housing space 2 for housing the washing machine and the dryer.

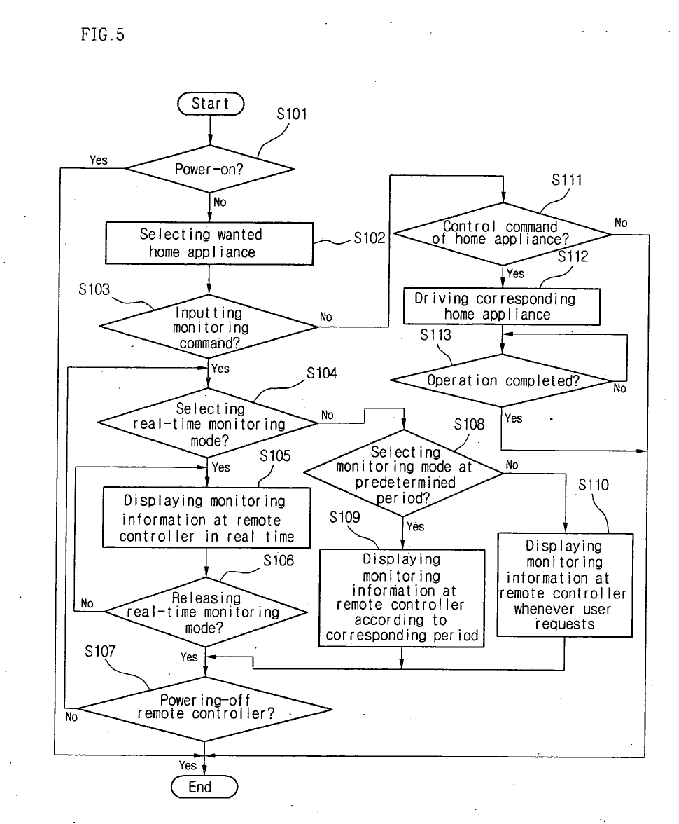

FIG. 5 is a flowchart illustrating the monitoring method of the home appliance placed within the certain distance according to an embodiment of the present invention. However, since a general method of individually operating the washing machine or the dryer is well known in the art, a detailed description thereof is omitted. A relation between the remote controller, and the washing machine and the dryer is concentratively described.

Referring to FIG. 5, after the user inputs a power-on command to the remote controller (S101), he/she selects a wanting home appliance placed within the certain distance (S102). The home appliance can be also the washing machine or the dryer, and can be also other home appliances at some distances.

After that, it is determined whether or not the user inputs a monitoring command (S103). The monitoring command inputting step is the step of determining whether or not the user intends to monitor the operation state of a specific home appliance selected through the selection step (S102). Next, if it is determined as the determination result (S103) that the user inputs the monitoring command, it is determined whether or not the user selects a real-time monitoring mode (S104). After that, if it is determined as the determination result (S104) that the user selects the real-time monitoring mode, the operation state of the home appliance selected by the user is received from the home appliance and displayed in real time on a display window of the remote controller placed indoor (S105). After that, if the user does not release the real-time monitoring mode, the monitoring is continuously performed (S106). If the user releases the real-time monitoring mode, it is determined whether or not the remote controller is powered off (S107). After that, if the power is not off and the real-time monitoring mode is released, it returns to the monitoring-mode selecting step (S104).

In the meantime, if the user does not select the real-time monitoring mode in the monitoring mode selection step (S104), it is determined that a monitoring mode having a predetermined period is selected (S108). Next, if the monitoring mode having the predetermined period is selected in the monitoring mode determination step (S108), monitoring information is received from the selected home appliance depending on a user's setting period or depending on a previously inputted period to be displayed at the remote controller (S109).

Further, if the user does not select to monitor at a predetermined period in the monitoring mode determination step (108), the monitoring information of the selected home appliance is received and displayed at the remote controller whenever the user wants to monitor (S110).

Alternatively, if it is determined that the user does not input the monitoring command in the monitoring determination step (S103), it is determined whether or not a control command is inputted to the home appliance (S111). After that, if it is determined that the user inputs the control command in the determination step (S111), the control command is transmitted to a corresponding home appliance to operate the home appliance according to the control command (S112), and a corresponding operation control is continuously performed until a operation completion command is received (S113). In a case where both of the monitoring command and the control command are not inputted, the remote controller can be automatically powered off and terminated after the lapse of a predetermined time.

The monitoring information includes information on the current operation states of the washing machine and the dryer, a supplied state of water, a rotation state of a drum, a state of the laundry, normal or abnormal operation, an internal temperature/humidity of the drum and the like, and can include a plurality of information not limited to it.

In the above-described monitoring method for the home appliance placed within the certain distance, the operation state of the home appliance selected by the user can be monitored every period/time selected by the user. Furthermore, in a case where the user intends to monitor the selected home appliance in real time, the operation state of the home appliance selected at the display window of the remote controller can be also monitored in real time. Since the user can conveniently monitor the operation state of the home appliance placed within the certain distance as described above, the user convenience can be increased.

Further, since a specific home appliance can be also controlled through the remote controller, the user convenience can be more increased.

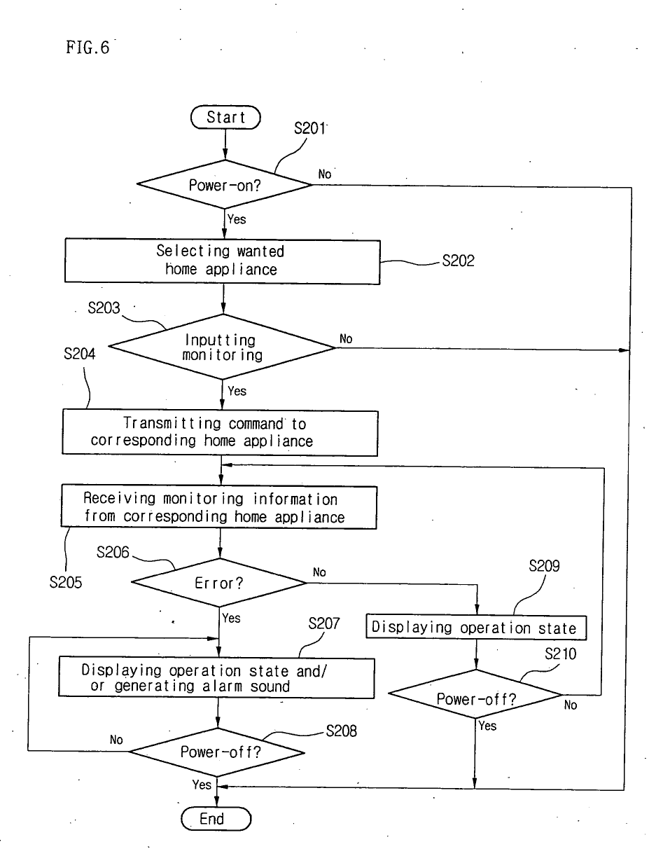

FIG. 6 is a flowchart illustrating a monitoring method of the home appliance placed within the certain distance according to another embodiment of the present invention. This embodiment relates to a method of allowing the user to promptly cope with the case where the monitored home appliance erroneously operates due to several causes.

Referring to FIG. 6, the monitoring method is in detail described according to the present invention. First, after a user inputs a power-on command to a remote controller (S201), he/she selects a wanting home appliance (S202). Next, it is determined whether or not the user inputs the monitoring command (S203). After that, if it is determined that the user inputs the monitoring command as a determination result (S203), the monitoring command is transmitted to a corresponding home appliance (S204). Next, the monitoring information is received from the home appliance transmitting the monitoring command (S205). After that, it is determined whether or not the received monitoring information has the error information (S206). If the received monitoring information has the error information as a determination result of error (S206), the operation state is displayed on the display window of the remote controller and at the same time, an alarm message is generated through an alarming unit to inform the user of the erroneous operation of the home appliance (S207). If the user confirms the error message to input a power-off command (S208), the alarm message is terminated. In a case where the user does not confirm the error message for a long time, the alarm message can be also terminated after the lapse of a predetermined time.

Alternatively, if it is determined that the received monitoring information does not include the error information as the determination result of error (S208), the operation state is displayed (S209). If the power-off command is not inputted, the monitoring is continuously performed in the reception step of the monitoring information (S205).

In the meantime, the user controls the remote controller to transmit the control command such as power cut-off while the home appliance operates before the power-off steps (S208)(S210), thereby controlling the home appliance by the remote controller.

The inventive monitoring method has an effect in that, in a case where the home appliance placed within the certain distance is erroneously operated, the user can more promptly detect the error, thereby more increasing the user convenience. Further, the inventive monitoring method has an effect in that the user promptly copes with the error in the course of the washing and drying strokes, thereby more increasing conveniences in progresses of the washing and drying strokes.

Even in a case where the washing machine and the dryer are of an integral type using a single drum, the present invention can conveniently perform the monitoring as one feature of a spirit of the present invention. At this time, the communication can be also performed through a single communication line.

When the home appliance is installed at the place within the certain distance such as an outdoor warehouse and an underground room, the operation state of the home appliance can be monitored even without a separate networking equipment. Therefore, the present invention has an effect in that it is convenient that the user does not need to directly go to the place within the certain distance.

Further, the present invention has an effect in that, since the user can perform the operation control of the home appliance placed within the certain distance, the user convenience can be more increased, and since the user can immediately cope with a dangerous environment, a safety is increased.

Furthermore, the present invention has an effect in that, since the user can see the portable remote controller anywhere to confirm the operation state of the home appliance, it is more convenient.

Further, the present invention has an effect in that, since only a simple control path is provided without the separate networking equipment, the advantages of the present invention can be provided without a difficulty of installation.

Furthermore, the present invention has an effect in that, since the communication modules of the remote controller and the home appliance can be individually used as the separate units, the user can independently purchase each of communication appliances related to the present invention only when he/she wants to do, thereby providing more convenience.

It will be apparent to those skilled in the art that various modifications and variations can be made in the present invention. Thus, it is intended that the present invention covers the modifications and variations of this invention provided they come within the scope of the appended claims and their equivalents.

1. A monitoring system for a home appliance placed within certain distance, the monitoring system comprising:
an indoor space in which a user lives;
a housing space being at a distance from the indoor space;
a home appliance being placed in the housing space and having a communication module for communicating with the external of the housing space; and
a remote controller placed in the indoor space, for communicating with the communication module to receive monitoring information of the home appliance, thereby monitoring an operation state of the home appliance.

2. The monitoring system according to claim 1, wherein the housing space is an underground room or a warehouse.

3. The monitoring system according to claim 1, wherein the communication module is free to detach from the home appliance.

4. The monitoring system according to claim 1, wherein the communication module and the home appliance are communicated with each other by using one or two of a power line communication, a wireless communication and a wire communication.

5. The monitoring system according to claim 1, wherein the remote controller is fixed to a wall of the indoor space.

6. The monitoring system according to claim 1, wherein the remote controller is portable.

7. The monitoring system according to claim 1, wherein the home appliance is a washing machine and/or a dryer.

8. The monitoring system according to claim 1, wherein the home appliance is provided in plural.

9. The monitoring system according to claim 1, wherein the remote controller has an alarm generating unit for alarming that the home appliance is in abnormal operation.

10. The monitoring system according to claim 1, wherein the remote controller has a displaying unit for displaying monitoring information.

11. The monitoring system according to claim 1, further comprising a power unit integrated with the remote controller.

12. The monitoring system according to claim 1, wherein the remote controller has a communicating unit for communicating with the communication module.

13. The monitoring system according to claim 1, wherein the monitoring system communicates with the communication module and is provided separately from the remote controller as a separate unit.

14. The monitoring system according to claim 1, wherein the home appliance and/or the remote controller has a key inputting unit for user manipulation.

15. The monitoring system according to claim 1, wherein the home appliance has displaying units for displaying operation states of the home appliance for themselves.

16. The monitoring system according to claim 1, wherein the monitoring information has error information of the home appliance.

17. The monitoring system according to claim 1, wherein each of the home appliances has a micro processor for controlling an operation of the remote controller and/or the home appliance.

18. A monitoring method for a home appliance placed within certain distance, the monitoring method comprising the steps of:
analyzing monitoring information of the home appliance from the home appliance placed within the certain distance;
transmitting the monitoring information to a remote controller; and
displaying the monitoring information on the remote controller.

19. The monitoring method according to claim 18, wherein the monitoring information is analyzed or transmitted at the home appliance, or displayed on the remote controller according to user's setting information.

20. The monitoring method according to claim 18, wherein the monitoring information is displayed in real time or at a predetermined period or at the time of a user's request.

21. The monitoring method according to claim 18, wherein the home appliance is a washing machine and/or a dryer.

22. The monitoring method according to claim 18, wherein the home appliance receives a control command from the remote controller.

23. The monitoring method according to claim 18, wherein the monitoring information has at least error information of the home appliance.

24. The monitoring method according to claim 18, wherein the home appliance is the washing machine and/or the dryer, and the monitoring information has at least one selected from information on a current operation state of the washing machine and/or the dryer, a supplied state of water, a rotation state of a drum, a state of a laundry, an internal temperature/humidity of the drum, and error.

25. The monitoring method according to claim 18, wherein the monitoring information is transmitted from the home appliance to the remote controller by using at least one of a power line communication, a wire communication, and a wireless communication.

26. The monitoring method according to claim 18, wherein the remote controller generates alarm when the monitoring information has the error information.

27. The monitoring method according to claim 18, wherein the monitoring information is displayed at the remote controller.

28. The monitoring method according to claim 18, wherein a single remote controller displays the monitoring information of a plurality of home appliances.

29. A monitoring method for a home appliance placed within certain distance, the monitoring method comprising the steps of:
transmitting monitoring information of the home appliance from the home appliance to a remote controller; and
displaying the monitoring information at a remote controller.

30. The monitoring method according to claim 29, further comprising the step of: transmitting a control command for controlling an operation of the home appliance from the remote controller to the home appliance.

31. The monitoring method according to claim 29, wherein the transmitting of the monitoring information is performed when there is a request from the remote controller.

32. A monitoring system for a home appliance placed within certain distance, the monitoring system comprising:
a washing machine and/or a dryer having a communication module to communicate with the external; and
a remote controller placed within the certain distance from the washing machine and/or the dryer, for receiving and displaying monitoring information of the washing machine and/or the dryer by communicating with the communication module.
